(19) United States
(12) Patent Application Publication
(10) Pub. No.: US 2019/0078602 A1
(43) Pub. Date: Mar. 14, 2019

(54) CLIP

(71) Applicant: NEWFREY LLC, New Britain, CT (US)

(72) Inventors: Daisuke SHINOZAKI, Toyohashi-shi (JP); Hiroto MATSUNO, Toyohashi-shi (JP)

(21) Appl. No.: 16/131,502

(22) Filed: Sep. 14, 2018

(30) Foreign Application Priority Data
Sep. 14, 2017 (JP) 2017-176343

(51) Int. Cl. F16B 21/08; F16B 2/22

(52) U.S. Cl. CPC F16B 21/086; F16B 2200/50; F16B 2/22; F16B 21/084

(57) ABSTRACT

A clip comprises a pin and bushing. The pin comprises a pin flange, a pin flange hole formed in the pin flange, a plurality of pin leg parts extending downward around the pin flange hole. The bushing comprising a bushing flange that can stow the pin flange, a plurality of bushing flange holes formed around the center axis of the bushing flange into which the pin leg parts can be inserted, bushing leg parts extending downward along the center axis of the bushing flange, and bushing leg recess parts formed extending along the outer circumference of the bushing leg part. The pin leg tip parts of the pin leg parts protrude inwards, the lower part of the bushing leg recess part is a shallow bushing leg spreading part and when the pin leg tip parts contact the bushing leg spreading part, the pin leg parts are spread.

### CROSS-REFERENCE TO RELATED APPLICATION

This application claims priority from Japanese Patent Application No. 2017-176343, filed on Sep. 14, 2017, the entire disclosure of which is incorporated herein by reference.

### BACKGROUND OF THE INVENTION

The present invention is related to a clip used to attach the mounting members of an undercover or the like to members to be mounted to, such as an automotive panel or the like. In further detail, the present invention pertains to a clip made up of 2 parts: a pin and a bushing.

In general, clips are used to attach mounting members of an undercover or the like to members to be mounted to, such as automotive panels or the like. Many clips of this type have been suggested in the past. One clip sandwiches the area around a mounting hole in a sheet member using two components of the clip, and the clip is engaged with a threaded stud protruding from the member to be mounted to, such as a panel or the like.

Other clips are made up of two components: a pin and bushing where the pin is press-fit into the opening on the bushing body spreading a locking tab provided on the body locking to a mounting hole in the member to be mounted to.

Patent reference 1 discloses a clip comprising a pin and a grommet (alternatively called a bushing) with an insertion hole for insertion of the pin and a plurality of leg pieces. When a pin is inserted in the insertion hole of the grommet, the leg parts are spread. A base (alternatively called a member to be mounted to) and mounting member attached to the base are sandwiched between the spread leg parts of the grommet and the flange attaching the mounting member to the base.

The clip of patent reference 1 is provided with wing parts extending in a wing shape from the center leg of the pin outward and the wing parts prevent intrusion of foreign materials such as gravel into the insertion hole of the grommet.

However, the method for mounting the clip of patent reference 1 is to set the pin and grommet in temporary locked state where the mounting hole positions of the base and part are aligned; the clip is inserted in the mounting hole, and the pin is pressed in. It is not feasible to first attach the clip to a part such as an undercover and then attach it to a base.

Patent reference 2 discloses a clip comprising a pin and bushing with a plurality of pin leg parts hanging down from a pin flange, penetration holes for the pin legs formed in the bushing flange, and open legs formed in the bushing leg parts. At the tip of the pin leg parts, a first lock is formed to retain the pin leg parts spread by the open leg parts in a permanent locked state, and a second lock is formed in a position different from that of the first lock for retention in a temporary locked state.

The penetration holes for the pin leg parts restrict spreading of the pin leg parts in the radial direction of the pin leg parts to enable insertion of the tips of the pin leg parts in the mounting holes of the member to be mounted to.

Regarding the clip of patent reference 2, in order to remove a clip that has been attached, even if the pin leg parts are spread deformed in the outward radial direction, raising the pin from the bushing to temporary locked state forcefully deforms the leg parts to their original non-spread deformed state by means of the penetration holes for the pin leg parts. Therefore, they can easily be re-fastened.

However, the mounting method of the clip of patent reference 2 is to set the pin and grommet in temporary locked state where the mounting hole positions of the mounting member and member to be mounted to are aligned, the clip is inserted in the mounting hole, and the pin is pressed in. It is not feasible to first attach the clip to a mounting member and then attach it to a base.

Patent reference 3 discloses a retaining fitting comprising a shaft part inserted in the mounting hole of a sheet shaped member (mounting member), a flange, a pair of holding pieces in the shape of a pantograph, and a head connected to the end of each of the holding pieces.

A guidance member, guiding the head to the shaft part when the holding pieces are folded, is provided on the head. To retain the holding pieces in a folded state, a locking tab is formed on the guidance member, and a locking shoulder is formed on the shaft part. An anchor leg locking part is formed on the guidance member to enable locking into a hole of a panel (member to be mounted to) on a vehicle body or the like.

The head of the retaining fitting is pushed into the mounting hole of the sheet shaped member to mount the retaining member to the sheet shaped member and cause the flange to contact the bottom surface of the sheet shaped member. Next, pushing the head forcefully toward the flange side will cause the holding pieces to bend in the radial outward direction centered at the hinge, and thus, the retaining fitting is mounted to the sheet shaped member. Then, the anchor leg locking part on the flange side of the retaining fitting is pushed into the hole of the panel to secure the sheet shaped member to the panel (member to be mounted to) such as an automobile body.

With regard to the retaining member of patent reference 3, a guidance member is provided to guide the heads towards the shaft when the holding pieces are bent, so the holding pieces can be bent without disturbing the pantograph shape. Therefore, surface contact such that the upper surface of the sheet shaped member has appropriate pressure is feasible.

The retaining member of patent reference 3 is first mounted to the sheet shaped member, then pushing the anchor leg locking part into the hole on the panel enables securing the sheet shaped member to the panel.

However, as to the retaining member of patent reference 3, the holding piece can be seen from outside, and its appearance was poor.

The clips of patent references 1 and 2 cannot be attached to the mounting member first and then attached to the member to be mounted to. The retaining member of patent reference 3 enables attaching the clip to the mounting member first, but the holding piece is on the outside, and its appearance is poor.

Therefore, a clip that can first be mounted to the mounting member of an undercover or the like of an automobile or the like and then be attached to the member to be mounted to was needed.

Patent reference 1: Japan Unexamined Patent Application 2012-2655.

Patent reference 2: Japan Unexamined Patent Application 2011-127708.

Patent reference 3: Japan Unexamined Patent Application H08-159118.

### BRIEF SUMMARY OF THE INVENTION

Therefore, an object of the present invention is to provide a clip that enables first attaching it to a mounting member and then attaching it to the member to be mounted to.

In order to achieve this object, the present invention comprises a pin and bushing. The pin comprises a plurality of pin leg parts hanging down from a pin flange. The bushing comprises a bushing leg part and a bushing leg recess part on the outer circumference of the bushing leg part for stowing each of the pin leg parts of the pins. As the pin leg parts are moved downwards along the bushing leg recess part, the pin leg parts are spread by a bushing leg spreading part under the bushing leg recess part. The bushing comprises a holding piece in the shape of a pantograph enabling attaching the mounting member to the bottom of the bushing flange beforehand.

A first aspect of the present invention is a clip comprising a pin and a bushing, the pin comprising a pin flange, a pin flange hole formed in the pin flange, a plurality of pin leg parts extending downward around the pin flange hole of the pin flange, the bushing comprising a bushing flange that can stow the pin flange, a plurality of bushing flange holes formed around the center axis of the bushing flange into which the pin leg parts can be inserted, bushing leg parts extending downward along the center axis of the bushing flange and downward in between adjacent bushing flange holes, bushing leg recess parts extending along the outer circumference of each bushing leg part that are able to stow the pin leg parts, below the bushing flange, a pair of holding piece retention parts, a pair of upper holding pieces connected via the pair of holding piece retention parts and a first hinge, a pair of lower holding pieces connected via the pair of upper holding pieces and a second hinge, and a holding piece lower part connected between the pair of lower holding pieces via a third hinge.

As the pin comprises a pin flange and the bushing comprises a bushing flange enabling the bushing to stow the pin flange, the pin flange can be pushed inside the bushing flange.

With the pin comprising a plurality of pin leg parts extending downward around the pin flange hole of the pin flange and the bushing comprising a plurality of bushing flange holes that the pin leg parts can be inserted into, bushing leg parts, and bushing leg recess parts extending downward around the outer circumference of each bushing leg part, the pin leg parts can be inserted in the bushing flange holes and stowed in the bushing leg recess parts enabling movement in the vertical direction of the pin relative to the bushing.

With the bushing comprising a pair of holding piece retention parts, a pair of upper holding pieces connected via the pair of holding piece retention parts and a first hinge, a pair of lower holding pieces connected via the pair of upper holding pieces and a second hinge, and a holding piece lower part connected between the pair of lower holding pieces via a third hinge under the bushing flange, the pair of upper holding pieces and pair of lower holding pieces can be opened and closed in a pantograph shape.

A flange locking tab is preferably formed at the lower end of the bushing flange of the bushing, and a bottom protruding part that can be engaged with the flange locking tab is preferably formed at the bottom of the holding piece lower part.

A flange locking tab being formed at the lower end of the bushing flange and a bottom protruding part that can be engaged with the flange locking tab formed in the holding piece lower part enables collapsing the pair of upper holding pieces and the pair of lower holding pieces and securing them in the collapsed position.

It is preferable to have pin leg grooves extending downward formed on the outer circumference of each of the pin leg parts of the pin, to have a first lock formed in the pin leg groove protruding from the pin leg groove and a second lock formed between the first lock and pin flange, and for flange hole protruding parts that can engage with the first lock and second lock formed in the bushing flange holes of the bushing.

When a first lock and second lock are formed in pin leg grooves and flange hole protruding parts are formed in the bushing flange holes, the first lock and second lock can engage with flange hole protruding parts enabling locking the pin with respect to the bushing at two positions.

It is preferable for the tip part of each pin leg of the plurality of pin leg part tips to protrude inside, for the bushing leg recess part on the outer circumference of the bushing leg parts to become shallower at the lower part becoming a bushing leg spread part, and for a spread part stepped part to be formed at the bottom end of the bushing leg spread part into which the tip parts of the pin legs can engage.

If the tip parts of each pin leg of the plurality of pin leg part tips protrude inside and the bushing leg recess part becomes shallower at the lower part becoming a bushing leg spread part, when the tips of the pin legs move from the bushing leg recess part to the bushing leg spread part, the pin leg parts can be spread.

If a step part for spreading is formed with a step shape that can engage with the pin leg tip parts at the bottom of the bushing leg spread part, the pin leg tip parts can engage with the step part for spreading, securing the pin leg parts in a spread state, enabling retaining the member to be attached to in an attached state.

A second aspect of the present invention is a clip assembly of a pin and a bushing, the pin comprising a pin flange, a pin flange hole formed in the pin flange, a plurality of pin leg parts extending downward around the pin flange hole of the pin flange, the bushing comprising a bushing flange that can stow the pin flange, a plurality of bushing flange holes formed around the center axis of the bushing flange into which the pin leg parts can be inserted, bushing leg parts extending downward along the center axis of the bushing flange and downward in between adjacent bushing flange holes, bushing leg recess parts formed extending downward along the outer circumference of each bushing leg part, below the bushing flange, a pair of holding piece retention parts, a pair of upper holding pieces connected via the pair of holding piece retention parts and a first hinge, a pair of lower holding pieces connected via the pair of upper holding pieces and a second hinge, and a holding piece lower part connected between the pair of lower holding pieces via a third hinge, the pin leg parts inserted in the bushing flange holes, and pin leg parts stowed in the bushing leg recess parts.

When the pin leg parts are inserted in the bushing flange holes and pin leg parts are stowed in the bushing leg recess part, the bushing leg parts and pin leg parts form a single cylinder shape which can easily be inserted in the mounting hole of the member to be mounted to.

It is preferable to have pin leg grooves extending downward formed on the outer circumference of each of the plurality of pin leg parts of the pin, to have a first lock formed in the pin leg groove protruding from the groove and a second lock formed between the first lock and pin flange, for flange hole protruding parts that can engage with the first lock and second lock formed in the bushing flange holes of the bushing, and for the flange hole protruding parts to engage with the first lock to enter a temporary locked state.

When the flange hole protruding parts are engaged with the first lock forming a temporary locked state, the pin will not readily move relative to the bushing, so the clip can easily be mounted in the mounting hole of the mounting member.

A third aspect of the present invention is a pin used for a clip comprising a pin and a bushing, the pin comprising a pin flange, a pin flange hole formed in the pin flange, and a plurality of pin leg parts extending downward around the pin flange hole of the pin flange; whereas pin leg grooves are formed extending downward on the outer circumference of each of the plurality of pin leg parts of the pins; and whereas a first lock is formed in the pin leg grooves protruding from the pin leg grooves, and a second lock is formed between the first lock and the pin flange.

A fourth aspect of the present invention is a bushing used for a clip comprising a pin and a bushing, the bushing comprising a bushing flange that can stow the pin flange, a plurality of bushing flange holes formed around the center axis of the bushing flange into which the pin leg parts can be inserted, bushing leg parts extending downward along the center axis of the bushing flange and downward in between adjacent bushing flange holes, bushing leg recess parts formed extending along the outer circumference of each bushing leg part, below the bushing flange, a pair of holding piece retention parts, a pair of upper holding pieces connected via the pair of holding piece retention parts and a first hinge, a pair of lower holding pieces connected via the pair of upper holding pieces and a second hinge, and a holding piece lower part connected between the pair of lower holding pieces via a third hinge.

With the present invention, a clip that can first be attached to a mounting member such as an undercover and then attached to the member to be mounted to such as an automotive panel can be obtained.

### BRIEF DESCRIPTION OF THE SEVERAL VIEWS OF THE DRAWINGS

FIG. 1 is a perspective view of the pin of the clip of embodiment 1 of the present invention.

FIG. 2 is a perspective view of the pin in FIG. 1 seen from a different direction.

FIG. 3 is a plan view of the pin of FIG. 1.

FIG. 4 is a front view of the pin of FIG. 1.

FIG. 5 is a bottom view of the pin of FIG. 1.

FIG. 6 is a right side view of the pin of FIG. 1.

FIG. 7 is a cross sectional view along line A-A of the pin in FIG. 4.

FIG. 8 is a cross sectional view along line C-C of the pin in FIG. 4.

FIG. 9 is a perspective view of the bushing of the clip of embodiment 1 of the present invention.

FIG. 10 is a perspective view of the bushing in FIG. 9 seen from a different direction.

FIG. 11 is a plan view of the bushing of FIG. 9.

FIG. 12 is a front view of the bushing of FIG. 9.

FIG. 13 is a bottom view of the bushing of FIG. 9.

FIG. 14 is a right side view of the bushing of FIG. 9.

FIG. 15 is a cross sectional drawing along line D-D of the bushing in FIG. 12.

FIG. 16 is an end view along line F-F of the bushing in FIG. 12.

FIG. 17 is a perspective view of the clip with the pin of FIG. 1 and bushing of FIG. 9 in a temporary locked state.

FIG. 18 is a perspective view of the clip in FIG. 17 seen from a different direction.

FIG. 19 is a plan view of the clip of FIG. 17.

FIG. 20 is a front view of the clip of FIG. 17.

FIG. 21 is a bottom view of the clip of FIG. 17.

FIG. 22 is a right side view of the clip of FIG. 17.

FIG. 23 is a cross sectional drawing along line G-G of the clip in FIG. 20.

FIG. 24 is a plan view of the clip of FIG. 17 that is first attached to the mounting member.

FIG. 25 is a front view of the clip of FIG. 24.

FIG. 26 is an end view along line J-J of the clip in FIG. 24.

FIG. 27 is an end view along line K-K of the clip in FIG. 24.

FIG. 28 is an end view along line L-L of the clip of FIG. 26.

FIG. 29 is a plan view of the clip of FIG. 24 permanently attached to the member to be mounted to.

FIG. 30 is a front view of the clip of FIG. 29.

FIG. 31 is an end view along line N-N of the clip of FIG. 29.

### DETAILED DESCRIPTION OF THE PREFERRED EMBODIMENTS

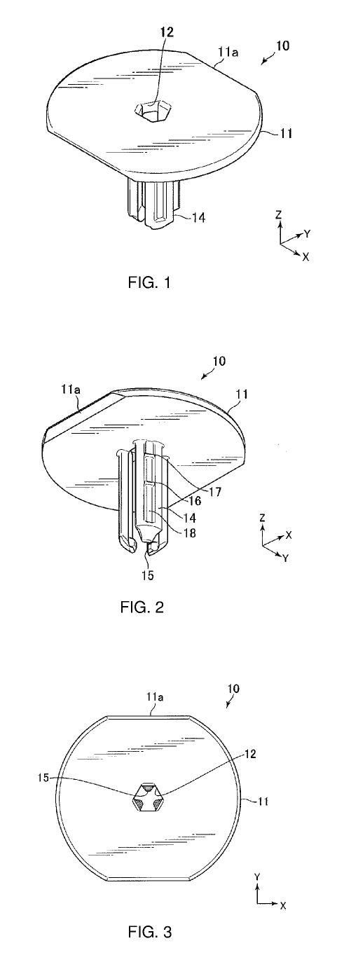

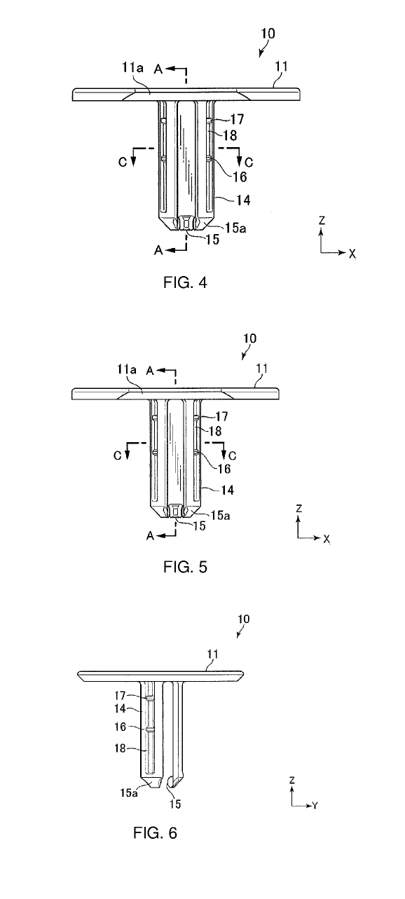

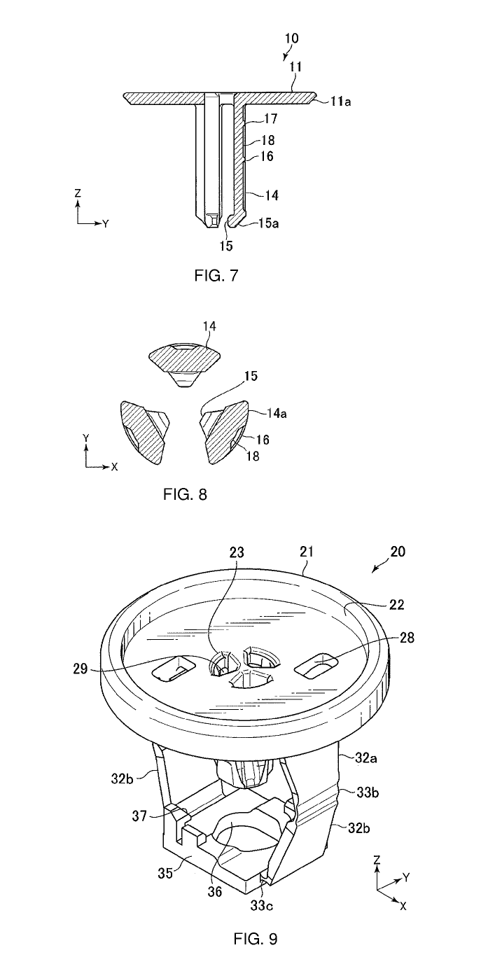

Next, the embodiment of the present invention will be described with reference to the drawings. FIGS. 1 to 9 show the pin 10 of the clip 1 of the embodiment of the present invention. FIG. 1 is a perspective view of the pin 10. FIG. 2 is a perspective view of the pin 10 from a different direction. FIG. 3 is a plan view, FIG. 4 is a front view, FIG. 5 is a bottom view, and FIG. 6 is a right side view of the pin 10. FIG. 7 is a cross sectional drawing along the line A-A of the pin 10 in FIG. 4. FIG. 8 is a cross sectional view along the line C-C of the pin 10 in FIG. 4.

In this specification, a coordinate axis is used to describe the shape of the clip 1 and the pin 10. The vertical direction of the center axis of the pin 10 is taken to be the Z direction; the direction of the straight line part 11a of the pin flange 11 perpendicular to the Z direction is taken to be the x direction; and the direction perpendicular to the x direction is taken to be the y direction.

As shown in FIG. 1 and FIG. 2, the pin 10 comprises a large diameter pin flange 11 and pin leg parts 14 extending downward from the pin flange 11. The pin flange 11 has a nearly disc shape with two opposing edge straight line parts 11a. The straight line parts 11a are provided to enable inserting the tip part of a screwdriver or the like under the pin flange 11 to remove the pin 10. A shape, such as a screwdriver or the like having a tip that can be inserted under the pin flange 11, is sufficient so this is not limited to a straight line shape.

As shown in FIG. 3, a pin flange hole 12 is formed in the center of the upper surface of the pin flange 11. In the embodiment of the present invention, the pin flange hole 12 is hexagonal in shape.

A plurality of pin leg parts 14 extend downwards from around the pin flange hole 12 of the pin flange 11. In the embodiment of the present invention, there are 3 pin leg parts 14. The pin leg parts 14 extend downward from 3 alternating sides of the hexagon shape of the pin flange hole 12. There must be a plural number of pin leg parts 14, but this is not restricted to 3 legs. The shape of the pin flange hole 12 will also change depending on the number of pin leg parts 14. There are intervals in the circumferential direction between adjacent pin leg parts 14 that extend downwards from 3 alternating sides of a hexagonal shape. The upper end of each of the pin leg parts 14 is joined to the pin flange 11 so that the pin leg parts can each independently bend in the radial direction. There is a hollow spacing at the center part of the plurality of pin leg parts 14. The bushing leg part 25 of the bushing 20 fits into this hollow.

As shown in FIG. 8, the cross section of the outer surface in the radial direction of each of the pin leg parts 14 is an arc shape, and pin leg grooves 18 extending in the vertical direction are formed in the center in the circumferential direction of the outer surface of the pin leg parts 14.

As shown in FIG. 6 and FIG. 7, a first lock 16 is formed near the middle between the pin flange 11 and pin leg tip parts 15 in the pin leg grooves 18 on the outer surface of each pin leg part 14. The first lock 16 is a shape protruding outwards in the radial direction from the pin leg grooves 18 that engages with the flange hole protruding parts 29 of the bushing 20 for a temporary locked state.

A second lock 17 is formed near the center between the pin flange 11 and the first lock 16 of the pin leg grooves 18 on the outer surface of each pin leg part 14. The second lock 17 is also a shape protruding outwards in the radial direction from the pin leg grooves 18 that engages with the flange hole protruding parts 29 of the bushing 20 for a permanent locked state.

As shown in FIG. 8, the outer surfaces of the first locks 16 formed in each of the pin leg grooves 18 are at the same circumferential height as the outer surfaces of the pin leg parts 14. As shown in FIG. 7, the outer surfaces of the second locks 17 formed in each of the pin leg grooves 18 are at the same circumferential height as the outer surface of the pin leg parts 14.

The first lock 16 and the second lock 17 do not extend beyond the outer surface of the pin leg parts 14, enabling smooth insertion of the pin leg parts 14 into the bushing flange holes 23 of the bushing 20.

As shown in FIG. 6, the pin leg tip parts 15 of the pin leg parts 14 protrude inwards. The pin leg tip parts 15 of the pin leg parts 14 are shaped to enable stowing in the bushing leg recess parts 26 of the bushing 20.

When the pin leg parts 14 are pushed downward, the pin leg tip parts 15 contact the bushing leg spreading part 27 of the bushing 20, causing the pin leg parts 14 to spread. The outer surfaces of the pin leg tip parts 15 have a sloped surface part 15a for easy insertion into the bottom hole 36 of the holding piece lower part 35 of the bushing 20.

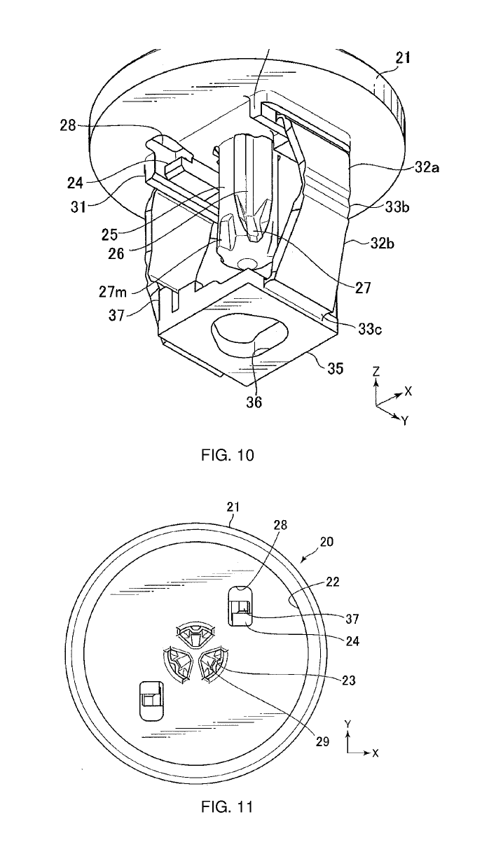

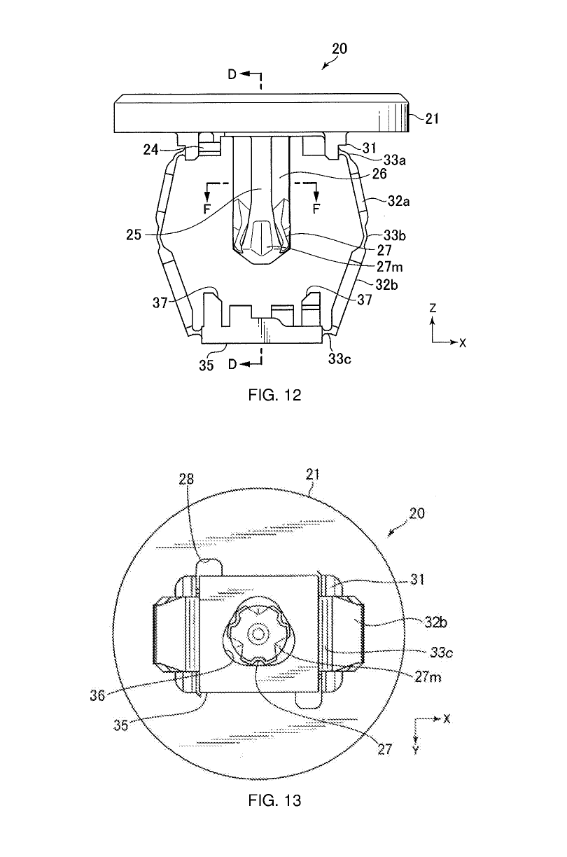

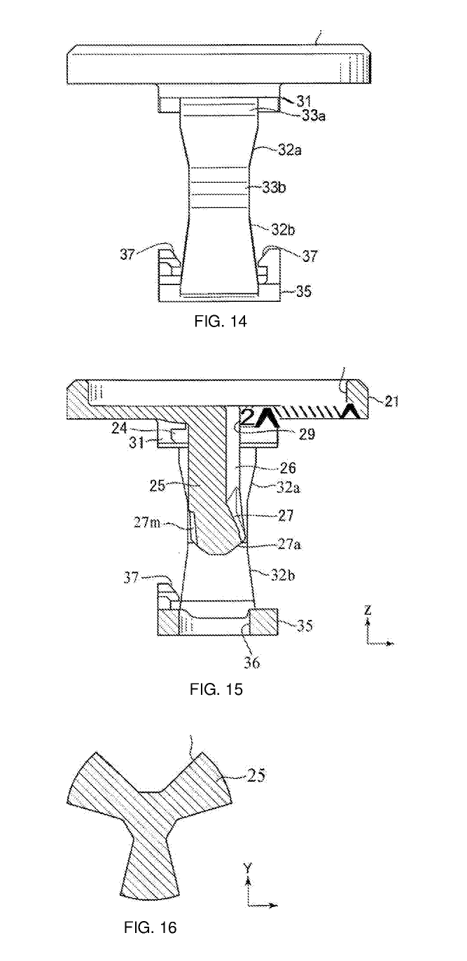

FIG. 9 to FIG. 16 show the bushing 20 of clip 1 of the embodiment of the present invention. FIG. 9 is a perspective view of the bushing 20. FIG. 10 is a perspective drawing of the bushing 20 viewed from a different direction. FIG. 11 is a plan view, FIG. 12 is a front view, FIG. 13 is a bottom view of the bushing 20, and FIG. 14 is a right side view.

FIG. 15 is a cross sectional drawing along line D-D of the bushing 20 in FIG. 12. FIG. 16 is an end view along line F-F of the bushing 20 in FIG. 12.

The direction of the center axis of the bushing 20 is taken to be the Z direction; the direction of the upper holding pieces 32a and of the lower holding pieces 32b is taken to be the x direction; and the direction perpendicular to the x direction is taken to be the y direction.

As shown in FIG. 9 and FIG. 10, the bushing 20 comprises a bushing flange 21 that has a larger diameter than the pin flange 11, a pair of holding pieces 32 below the bushing flange 21 that open and close in a pantograph shape, a holding piece lower part 35 that connects the bottom ends of the pair of holding pieces 32, and a bushing leg part 25 that hangs down from the center of the bushing flange 21. The bushing leg part 25 spreads the pin leg parts.

The bushing flange 21 has a diameter that is larger than the pin flange 11. A flange recess part 22 is formed in the upper surface of the bushing flange 21, enabling stowing of the pin flange 11. The inner diameter of the flange recess part 22 is slightly larger than the outer diameter of the pin flange 11. The depth of the flange recess part 22 is slightly larger than the thickness of the pin flange 11, and the pin flange 11 is set inside the flange recess part 22 when the clip 1 is in the permanent locked state. The depth of the flange recess part 22 can be roughly equivalent to the thickness of the pin flange 11. The flange recess part 22 can be omitted.

As shown in FIG. 11, a plurality of bushing flange holes 23 is formed in the center of the bushing flange 21 into which the plurality of pin leg parts 14 can be inserted. If there are three pin leg parts 14, there will also be three bushing flange holes 23. The three bushing flange holes 23 are lined up around the center axis of the bushing flange 21 at equally spaced intervals. The outer periphery of the bushing flange holes 23 is an arc shape. A line connecting the outer peripheries of the three bushing flange holes 23 forms a single circle. The respective pin leg parts 14 enter into each of the bushing flange holes 23.

As shown in FIG. 15, a flange hole protruding part 29 with a protrusion shape is formed in the center of the outer periphery of the arch shape of each bushing flange hole 23. Engaging of the flange hole protruding parts 29 with the first lock 16 of the pin leg parts 14 retains a temporary locked state, and engaging with the second lock 17 of the pin leg parts 14 retains a permanent locked state.

As shown in FIG. 16—which is a cross sectional view along the line F-F of the bushing 20 in FIG. 12—three bushing leg recess parts 26 are formed in the bushing leg part 25. When comparing this to FIG. 8—which is a cross sectional view of the line C-C of the pin 10 in FIG. 4—it can be seen that the pin leg parts 14 of the pin 10 are to be stowed in the bushing leg recess parts 26.

The lower part of the bushing flange holes 23 has three bushing leg recess parts 26 formed in the vertical direction to receive the three pin leg parts 14.

As shown in FIG. 15, the three bushing leg recess parts 26 become shallower close to the bottom of the bushing leg part 25 and become a bushing leg spreading part 27. When the pin leg parts 14 of the pin 10 are lowered along the bushing leg recess parts 26 of the bushing 20, the pin leg tip parts 15 of the pin leg parts 14 come into contact with the bushing leg spreading part 27 and are spread out.

A step part 27a is provided with a step formed at the tip of the bushing leg spreading part 27. In a permanent locked state, the pin leg tip parts 15 of the pin leg parts 14 engage with the spread parts step parts 27a, preventing removal.

As shown in FIG. 10 and FIG. 12, bushing leg tip grooves 27m are formed between adjacent bushing leg spreading parts 27 close to the tip part of the bushing leg part 25, to reduce material.

As shown in FIG. 11, flange openings 28 are formed in two locations opposite the outside of the bushing flange holes 23. The bottom protruding part 37 is stowed in a flange opening 28 when in permanent locked state.

A pair of flange locking tabs 24 is provided adjacent to the flange openings 28 on the bottom surface of the bushing flange 21. As shown in FIG. 15, the pair of flange locking tabs 24 has tabs extending in the y direction.

The pair of flange locking tabs 24 is adjacent to the pair of holding piece retention parts 31. When the pair of upper holding pieces 32a and lower holding pieces 32b are folded as described below, the bottom protruding part 37 engages with the flange locking tab 24.

As shown in FIG. 10 and FIG. 12, a pantograph part is formed in the bottom surface of the bushing flange 21. The pantograph part comprises the pair of holding piece retention parts 31, the pair of upper holding pieces 32a via a first hinge 33a, the lower holding pieces 32b via a second hinge 33b, and the holding piece lower part 35 via a third hinge 33c.

The pair of holding piece retention parts 31 extend in the Y direction. As shown in FIG. 12, the pair of upper holding pieces 32a extend diagonally downwards spreading out in the x direction via the first hinge 33a. The upper holding pieces 32a can bend at the hinges. The lower holding pieces 32b extend diagonally (axially downwards and radially inward) from the bottom of the upper holding pieces 32a via the second hinge 33b. The vertical height of the lower holding pieces 32b is nearly the same as the vertical height of the upper holding pieces 32a.

The holding piece lower part 35 is connected between the pair of lower holding pieces 32b via the third hinge 33c. The length of the holding piece lower part 35 in the x direction is roughly equivalent to the spacing between the pair of holding piece retention parts 31. As shown in FIG. 13, the external cross section of the holding piece lower part 35 is basically square.

The pairs of holding piece retention parts 31 and upper holding pieces 32a are connected by the first hinge 33a, the upper holding pieces 32a and lower holding pieces 32b are connected by the second hinge 33, and the lower holding pieces 32b and holding piece lower part 35 are connected by the hinge 33c; therefore enabling the second hinge 33b to expand outwards, the holding piece lower part 35 to move upwards and thus deform into the shape of a pantograph.

A bottom hole 36 is formed in the center part of the holding piece lower part 35. The bottom hole 36 is sized so as to enable the bushing leg part 25 to pass through. As the upper holding pieces 32a and lower holding pieces 32b fold, the holding piece lower part 35 remains level as it moves upward. The bushing leg part 25 passes through the bottom hole 36 protruding beneath the holding piece lower part 35. The upper holding pieces 32a and lower holding pieces 32b fold, so the bushing leg part 25 passes through the bottom hole 36 and the upper holding pieces 32a and lower holding pieces 32b fold together without disturbing the pantograph shape. As the upper holding pieces 32a and lower holding pieces 32b fold together, the second hinge 33b expands to the outside.

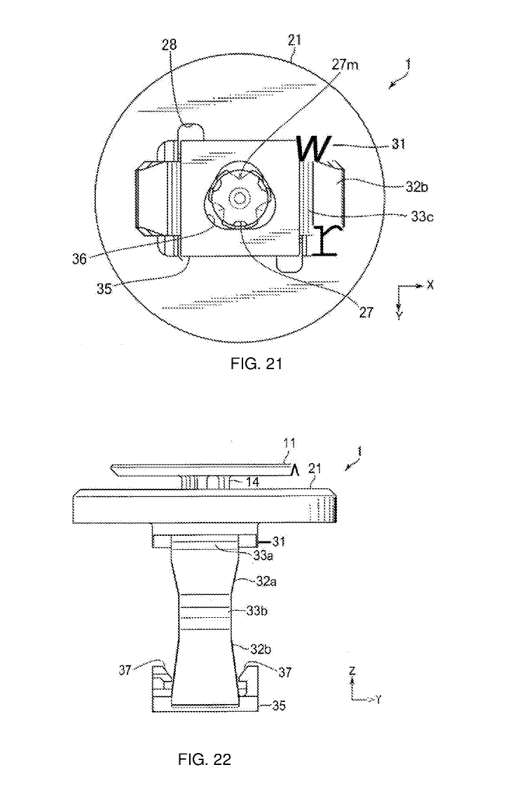

As shown in FIG. 21, the cross sectional shape of the bottom hole 36 is basically a triangle with each vertex as an arc. With the upper holding pieces 32a and lower holding pieces 32b in a folded state, the bushing leg spreading parts 27 faces each side of the triangle. With the pin leg parts 14 spread, each of the pin leg parts 14 contacts a side of the triangle and is made to pass through the bottom hole 36.

A pair of bottom protruding parts 37 are formed at the lower part of the flange opening 28 at the part opposite the holding piece lower part 35. The pair of bottom protruding parts 37 protrudes in the y direction. When the pair of upper holding pieces 32a and lower holding pieces 32b are folded the bottom protruding part 37 engages with the flange locking tab 24, enabling retaining of the permanent locked state.

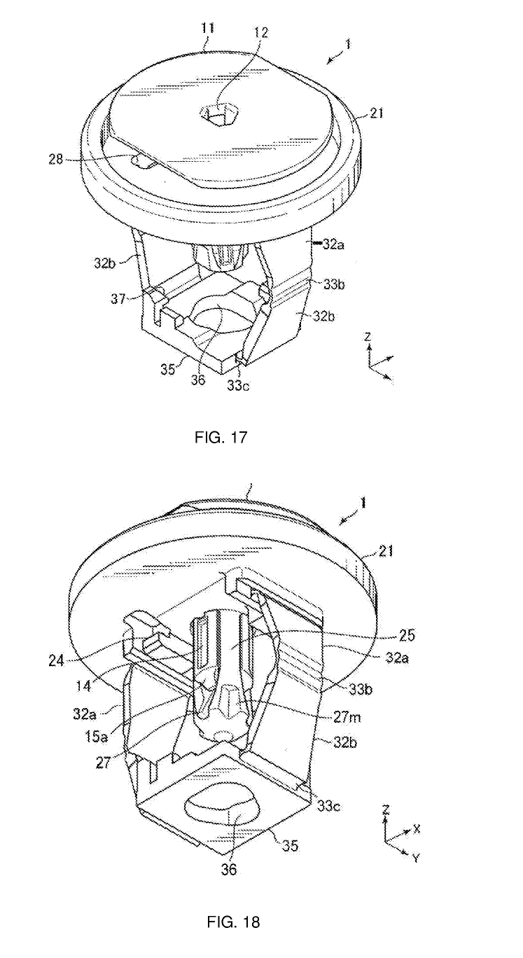

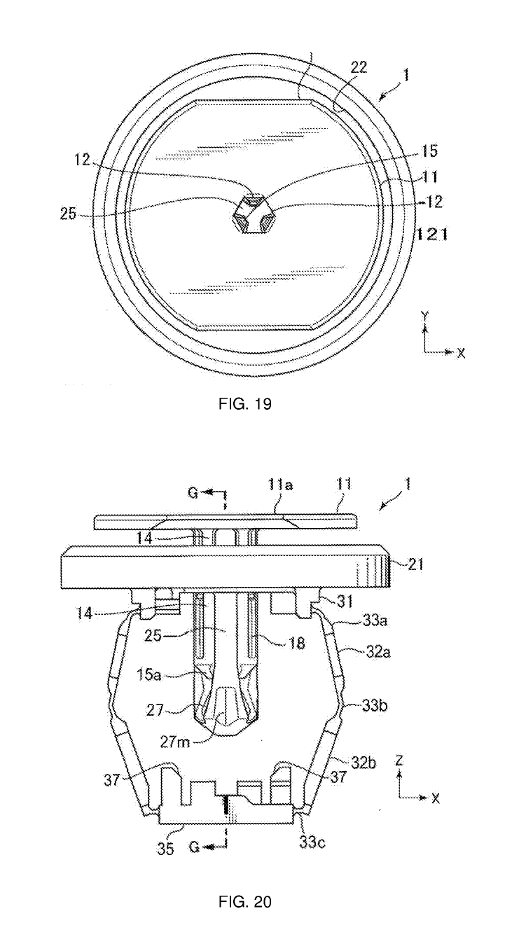

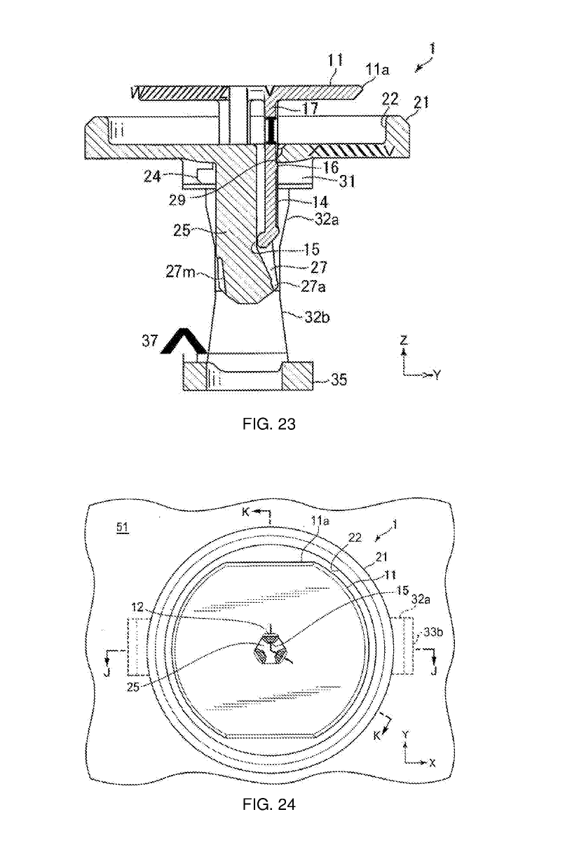

FIG. 17 is a perspective drawing of the clip 1 with the pin 10 and bushing 20 in temporary locked state. FIG. 18 is a perspective drawing of the clip 1 viewed from a different direction. FIG. 19 is a plan view; FIG. 20 is a front view; FIG. 21 is a bottom view; and FIG. 22 is a right side view of the clip 1. FIG. 23 is a cross sectional drawing along line G-G in FIG. 20.

In FIG. 17 to FIG. 23, the x direction, y direction, and z direction of the assembled clip 1 are the same as the x direction, y direction, and z direction of the pin 10 and the x direction, y direction, and z direction of the bushing 20.

The three pin leg parts 14 of the pin 10 are inserted into the three bushing flange holes 23 formed in the bushing flange 21 of the bushing 20 to set the pin 10 and the bushing 20 in a temporary locked state. The three pin leg parts 14 move downward along the bushing leg recess parts 26 of the bushing leg part 25.

As shown in FIG. 23, at the position the first locks 16 of the pin leg parts 14 move past the flange hole protruding parts 29, the pin leg parts 14 are positioned in the bushing leg recess parts 26 of the bushing leg part 25 but have not reached the bushing leg spreading part 27.

The pin 10 and the bushing 20 are in temporary locked state in this position.

In the temporary locked state, the first lock 16 of the pin leg parts 14 engages with the flange hole protruding parts 29 of the bushing 20, stopping the pin 10 from being pulled out. Also, the pin leg tip parts 15 of the pin leg parts 14 come into contact with the bushing leg spreading part 27; this opposes the push force on the pin 10, maintaining the temporary locked state.

As shown in FIG. 18 and FIG. 21, with the three pin leg parts 14 inserted into the bushing leg recess parts 26 of the bushing leg part 25, the external outer surface cross section of the pin leg parts 14 in the radial direction and the external outer surface cross section of the bushing leg part 25 in the radial direction are basically one circle.

We shall now describe the method of first attaching the clip 1 in temporary locked state to a mounting member 51. The mounting hole 53 of the mounting member 51 is sized to enable the holding piece lower part 35 to pass through, cause narrowing of the spacing of the second hinge 33b, enabling the upper holding pieces 32a and lower holding pieces 32b to pass through, and the pair of holding piece retention parts 31 to fit into the mounting hole 53. The mounting hole 53 can have the shape of a square, a rectangle, a circle or the like.

The clip 1 of FIG. 17 in temporary locked state is held, and the upper holding pieces 32a, the lower holding pieces 32b, and the holding piece lower part 35 of the bushing 20 are inserted from above into the mounting hole 53 of the mounting member 51. The spacing of the upper holding pieces 32a and the lower holding pieces 32b narrows to enable passing through the mounting hole 53, and the bottom surface of the bushing flange 21 comes into contact with the upper surface of the mounting member 51.

Next, the holding piece lower part 35 is pushed up, folding the upper holding pieces 32a and the lower holding pieces 32b. As the upper holding pieces 32a and lower holding pieces 32b fold, the upper surface of the upper holding pieces 32a comes into contact with the bottom surface of the mounting member 51.

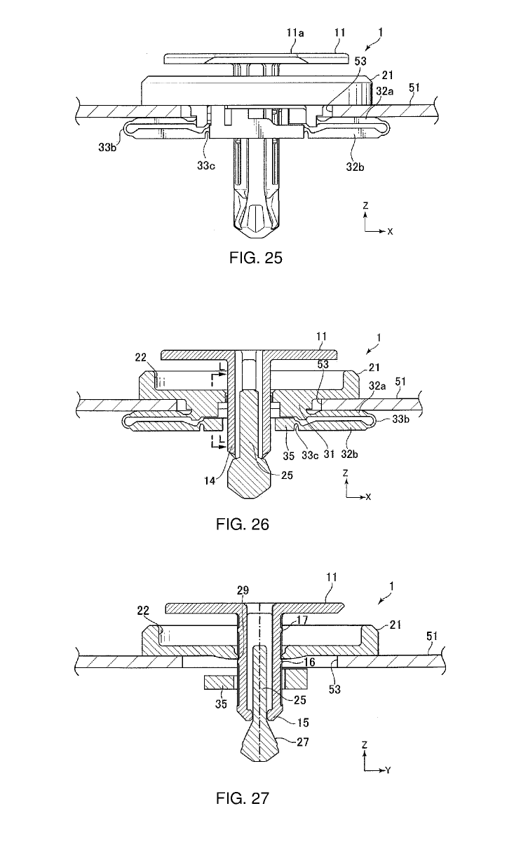

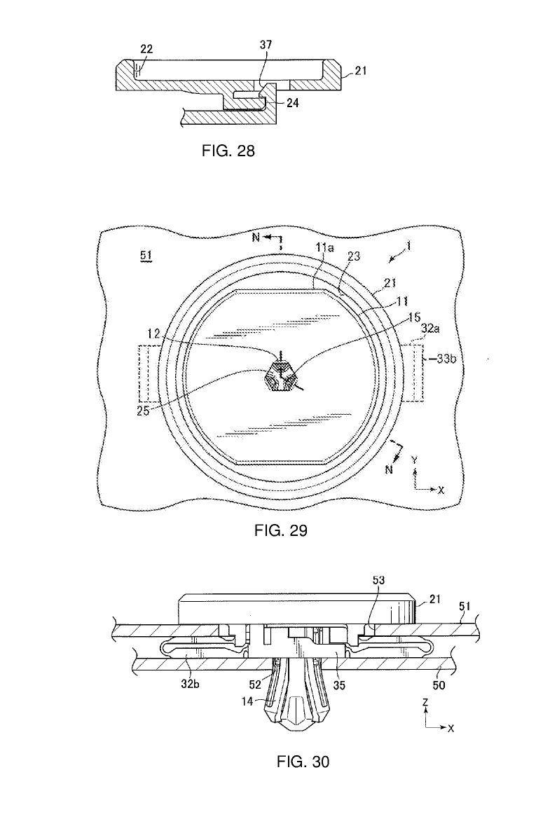

FIG. 24 is a plan view showing the upper holding pieces 32a and the lower holding pieces 32b folded and mounted to the mounting member 51. FIG. 25 is a front view. FIG. 26 is an end view along line J-J of the clip 1 in FIG. 24. FIG. 27 is an end view along line K-K of the clip 1 of FIG. 24; however, the y direction of the coordinate axis applies only to the right half. FIG. 28 is an end view along line L-L of the clip 1 of FIG. 26.

As shown in FIG. 28, the pair of bottom protruding parts 37 formed on the holding piece lower part 35 engage with the flange locking tabs 24. Thus, the upper holding pieces 32a and the lower holding pieces 32b are unable to return to the state prior to folding.

As shown in FIG. 26 and FIG. 27, the mounting member 51 is sandwiched between the bottom surface of the bushing flange 21 and the upper surface of the upper holding pieces 32a. The thickness of the mounting member 51 is roughly the same as the length of the spacing between the upper surface of the upper holding pieces 32a when folded and the bottom surface of the bushing flange 21. In this state, the pin leg tip parts 15 are positioned in the bushing leg recess parts 26 and are not in contact with the bushing leg spreading part 27. The pin leg parts 14 are not spread.

Thus, the clip 1 is first attached to the mounting member 51.

FIG. 29 is a plan view of the clip 1 permanently attached to the member to be mounted to 50.

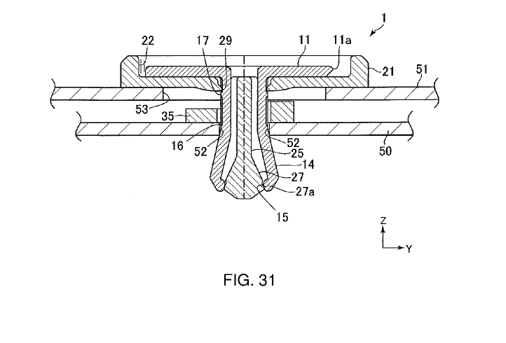

FIG. 30 is a front view. FIG. 31 is an end view along line N-N of the clip 1 of FIG. 29; however, the y direction of the coordinate axis applies only to the right half.

We shall now describe the method of mounting the clip 1 to the member to be mounted to 50. The pin leg parts 14 and the bushing leg part 25 of the clip 1 mounted to the mounting member 50 are inserted into the mounting hole 52 of the member to be mounted to 50. The mounting hole 52 of the member to be mounted to 50 is sufficient if the tip of the bushing leg part 25 of the clip 1 in a temporary locked state and the pin leg tip parts 15 of the pin leg parts 14 can pass through.

The bottom surface of the lower holding pieces 32b and the bottom surface of the holding piece lower part 35 come into contact with the member to be mounted to 50, stopping the clip 1. Next, when the pin flange 11 of the pin 10 is pushed into the flange recess part 22 of the bushing flange 21, the pin leg parts 14 are pushed against the bushing leg spreading part 27 of the bushing leg part 25 and are spread. As shown in FIG. 31, the pin leg tip parts 15 of the pin leg parts 14 engage with the spread part step part 27a at the tip of the bushing leg part 25, stopping the pin 10 from being pulled out.

Also, the second lock 17 of the pin leg parts 14 engages with the flange hole protruding parts 29 of the bushing flange 21, stopping the pin 10 from being pulled out.

The member to be mounted to 50 is sandwiched and secured between the pin leg parts 14 that are spread, the holding piece lower part 35, and the lower holding pieces 32b.

Thus, the clip 1 is permanently locked, and the mounting member 51 is attached to the member to be mounted to 50.

For removal of the clip 1 from the member to be mounted to 50, the tip of a screwdriver or the like is placed between the straight line part 11a of the pin flange 11 and the bushing flange recess part 22 in FIG. 31, and the pin flange 11 is pried up. This will cause the second lock 17 of the pin leg parts 14 and the flange hole protruding parts 29 of the bushing flange 21 to disengage, and the pin leg tip parts 15 of the pin leg parts 14 and the step part 27a of the bushing leg part 25 to disengage. The spread pin leg parts 14 of the pin 10 close up, enabling pulling upwards. The member to be mounted to 50 is released from being sandwiched between the pin leg parts 14 that are spread, the holding piece lower part 35, and the lower holding pieces 32b, thus enabling removal.

We shall next describe removal of the bushing 20 from the mounting member 51. Upon disengaging the bottom protruding part 37 of the holding piece lower part 35 and the flange locking tab 24 of the flange opening 28 using the tip of a screwdriver or the like, the folded upper holding pieces 32a and lower holding pieces 32b can return to the shape of a pantograph. Upon pushing so that the second hinges 33b become closer to each other, the bushing 20 can be removed from the mounting hole 53 of the mounting member 51.

The pin 10 and the bushing 20 thus removed can be used again.

The clip 1 made up of a pin 10 and the bushing 20 according to this embodiment of the present invention can first be attached to a mounting member 51, such as an undercover or the like and then attached to the member to be mounted to 50, such as an automotive panel or the like. Furthermore, after the pin 10 and the bushing 20 are removed, they can be used again.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A clip comprising:
a pin including:
a pin flange,
a pin flange hole formed in the pin flange,
a plurality of pin leg parts extending downward around the pin flange hole of the pin flange; and
a bushing including:
a bushing flange that can stow the pin flange,
a plurality of bushing flange holes formed around the center axis of the bushing flange into which the pin leg parts can be inserted,
a plurality of bushing leg parts extending downward along the center axis of the bushing flange and downward in between adjacent bushing flange holes,
a plurality of bushing leg recess parts extending along an outer circumference of each bushing leg part and operable to stow the pin leg parts,
a pair of holding piece retention parts below the bushing flange,
a pair of upper holding pieces connected to the bushing flange via the pair of holding piece retention parts and a first hinge,
a pair of lower holding pieces connected to the bushing flange via the pair of upper holding pieces and a second hinge, and
a holding piece lower part connected between the pair of lower holding pieces via a third hinge.

2. The clip according to claim 1, wherein a flange locking tab is formed at the lower end of the bushing flange of the bushing and a bottom protruding part that can be engaged with the flange locking tab is formed at the bottom of the holding piece lower part.

3. The clip according to claim 1, wherein pin leg grooves are formed extending downward on an outer circumference of each of the pin leg parts of the pin, a first lock is formed in the pin leg grooves protruding from the pin leg grooves and a second lock is formed between the first lock and pin flange, and flange hole protruding parts that can engage with the first lock and second lock are formed in the bushing flange holes of the bushing.

4. The clip according to claim 1, wherein:
each of the plurality of pin leg parts includes a pin leg tip part that protrudes inwards,
each of the bushing leg recess parts become shallower at the lower part and includes a bushing leg spread part,
a spread part step part in a step shape is located at the bottom end of the bushing leg spread part, and
when the pin leg tip parts engage with the spread part step part, the pin leg parts spread and are thus secured.

5. A clip assembly comprising:
a pin including:
a pin flange,
a pin flange hole formed in the pin flange,
a plurality of pin leg parts extending downward around the pin flange hole of the pin flange; and
a bushing including:
a bushing flange that can stow the pin flange,
a plurality of bushing flange holes formed around the center axis of the bushing flange into which the pin leg parts can be inserted,
a plurality of bushing leg parts extending downward along the center axis of the bushing flange and downward in between adjacent bushing flange holes,
a plurality of bushing leg recess parts extending along an outer circumference of each bushing leg part and operable to stow the pin leg parts,
a pair of holding piece retention parts below the bushing flange,
a pair of upper holding pieces connected to the bushing flange via the pair of holding piece retention parts and a first hinge,
a pair of lower holding pieces connected to the bushing flange via the pair of upper holding pieces and a second hinge, and
a holding piece lower part connected between the pair of lower holding pieces via a third hinge and
wherein the pin leg parts are inserted in and extend axially through the bushing flange holes and are stowed in the bushing leg recess parts.

6. The clip according to claim 5, wherein the outer circumference of each of the plurality of pin leg parts further includes a pin leg groove extending downward, a first lock is formed in the pin leg groove and protrudes from the groove, and a second lock is formed between the first lock and the pin flange, flange hole protruding parts engageable with the first lock and second lock are formed in the bushing flange holes of the bushing, and the flange hole protruding parts engage with the first lock to hold the pin and bushing in a temporary locked state.
